(19) United States
(12) Patent Application Publication
(10) Pub. No.: US 2004/0153429 A1
(43) Pub. Date: Aug. 5, 2004

(54) Method for creating a knowledge-based causal network

(76) Inventors: Joachim Horn, Munchen (DE); Marco Pellegrino, Vaterstetten (DE); Ruxandra Scheiterer, Geretsried (DE)

Correspondence Address: SIEMENS CORPORATION, INTELLECTUAL PROPERTY DEPARTMENT, 170 WOOD AVENUE SOUTH, ISELIN, NJ, 08830, US

(21) Appl. No.: 10/482,657

(22) PCT Filed: Jun. 21, 2002
(86) PCT No.: PCT/DE02/02280

(30) Foreign Application Priority Data
Jul. 3, 2001 (DE) 101 32 014.0

(51) Int. Cl. G06F 17/00; G06N 7/08; G06N 7/00

(52) U.S. Cl. 706/59

(57) ABSTRACT

The invention relates to a method for creating a causal network on the basis of knowledge acquisition. According to the invention, said knowledge acquisition is separated from the creation of said causal network and comprises the following steps: relevant knowledge is collected, and the knowledge in its entirety is structured to form a structured and complete representation thereof enabling the causal network to be created automatically by a computer.

The invention relates to a method for creation of a causal network (Bayesian network) based on knowledge acquisition.

The invention accordingly relates to the field of decision theory. Within the framework of this theory, classical probability theory has been extended to an extremely precise mathematical framework in order to make it possible to make rational decisions with computer assistance. Causal networks, which are also referred to as Bayesian networks, for graphical representations of causal relationships in a domain, and a large number of probability calculations already exist for these networks. Causal networks (which are described, for example, in F. V. Jensen: An Introduction to Bayesian Networks, UCL Press, 1996) represent an accurate and efficient framework for, for example calculation of the probability of any random variables in a predetermined set of observations.

Causal networks are used in widely differing fields, for example for assisting doctors' decisions (see Andreassen, M. Woldbye, B. Falck, S. K. Andersen: “MUNIN—A Causal Probabilistic Network for Interpretation of Electromyographic Findings”. Proceedings of the Tenth International Joint Conference on Artificial Intelligence, Milan, Italy, August 1987, pages 366-372; D. E. Heckerman, E. J. Horvitz, B. N. Nathwani: “Toward Normative Expert Systems: Part I. The Pathfinder Project”. Methods of Information in Medicine, Volume 31, 1992, pages 90-105; D. E. Heckerman, B. N. Nathwani: “Toward Normative Expert Systems: Part II. Probability-Based Representations for Efficient Knowledge Acquisition and Inference”. Methods of Information in Medicine, Volume 31, pages 106-116; P. J. F. Lucas, H. Boot, B. Taal: “A Decision-Theoretic Network Approach to Treatment Management and Prognosis”. Knowledge-Based Systems, Volume 11, 1998, pages 321-330; B. Middleton, M. A. Shwe, D. E. Heckerman, M. Henrion, E. J. Horvitz, H. P. Lehmann, G. F. Cooper: “Probabilistic Diagnosis Using a Reformulation of the INTERNIST-1/QMR Knowledge Base, II. Evaluation of Diagnostic Performance”. Methods of Information in Medicine, Volume 30, 1991, pages 256-267; K. G. Olesen, U. Kjaerulff, F. Jensen, F. V. Jensen, B. Flack, S. Andreassen, S. K. Andersen: “A MUNIN network for the Median Nerve—A Case Study on Loops”. Applied Artificial Intelligence, Volume 3, 1989, pages 385-403; M. A. Shwe, B. Middleton, D. E. Heckerman, M. Henrion, E. J. Horvitz, H. P. Lehmann, G. F. Cooper: “Probabilistic Diagnosis Using a Reformulation of the INTERNIST-1/QMR Knowledge Base. I. The Probabilistic Model and Inference Algorithms”. Methods of Information in Medicine, Volume 30, 1991, pages 241-250).

However, the knowledge acquisition process which is required to produce a causal network is, as before, a complex undertaking using complex systems, such as medical diagnosis. One particular difficulty in the creation of causal networks in this case is to design the knowledge acquisition process such that it can be carried out sufficiently completely by those without mathematical knowledge, such as doctors, in order to configure a valid causal network.

One object of the invention is to provide a method which makes it possible for a user to create a causal network based on a knowledge acquisition process, with as few problems as possible.

This object is achieved by the features of claim 1. Advantageous developments of the invention are specified by the dependent claims.

Accordingly, in the case of the method under discussion, the invention provides for the knowledge acquisition process to be carried out separately from the creation of the causal network. In particular, the knowledge acquisition process envisages the gathering of relevant knowledge, with the knowledge that has been gathered being structured to form a structured representation which is sufficiently complete that the causal network can be created automatically by means of a computer.

The invention accordingly adopts a new approach to knowledge acquisition and production of a causal network, with a mathematical method preferably being used to produce a subset from the gathered knowledge, such that the representation which results from this is complete.

Provision is preferably made for the relevant knowledge to be gathered by means of a software tool. This gathering by means of the software tool is preferably carried out by means of a dialogue on a display device, for example on the monitor of a computer in which the software tool is implemented.

One interesting field of application of the method according to the invention relates to the assistance that this makes possible to a medical decision. In this context, the invention preferably provides for the software tool to be designed to specify debilitations and findings, relationships between debilitations and findings, and specific boundary probabilities and conditional probabilities, and is designed to ensure that the gathered knowledge is sufficiently complete that the causal network can be created automatically by means of a compiler. Provision is in this case advantageously made for the software tool to use the debilitations and the findings as stochastic variables. In the case of assistance to a medical decision, as mentioned above, by means of the method according to the invention, provision is furthermore made for a selected debilitation, its boundary probability and additional information to be displayed on the display device. Provision is advantageously made in this case for the additional information to include promoting and constraining factors relating to the selected debilitation. In order to quantify the effects of the promoting and constraining factors, provision is advantageously made for conditional probabilities to be specified.

In order to assist the user in the knowledge acquisition process, the process of assisting the making of medical decisions as explained above provides for the symptoms associated with a selected debilitation to be displayed on a computer monitor, for example, together with the conditional probability of this debilitation causing that symptom.

The inventor of the present application has developed the application, as explained in essence above, of the method according to the invention for assistance to medical decision making as part of the so-called HealthMan-Project (T. Birkholzer, M. Haft, R. Hofmann, J. Horn, M. Pellegrino, V. Tresp: “Intelligent Communication in Medical Care”. Proceedings of the Joint European Conference on Artificial Intelligence in Medicine and Medical Decision Making (AIMDM 99) Aalborg, Denmark, June 1999, page 4). In this process, knowledge is first of all gathered and is transferred to a structured representation using a software tool, which is matched to medical use. This software tool is also referred to here as MedKnow.

In order to explain in more detail the knowledge acquisition process according to the invention for creation of a causal network, reference will once again be made to the process of assistance to medical decision making in conjunction with the drawing, in which:

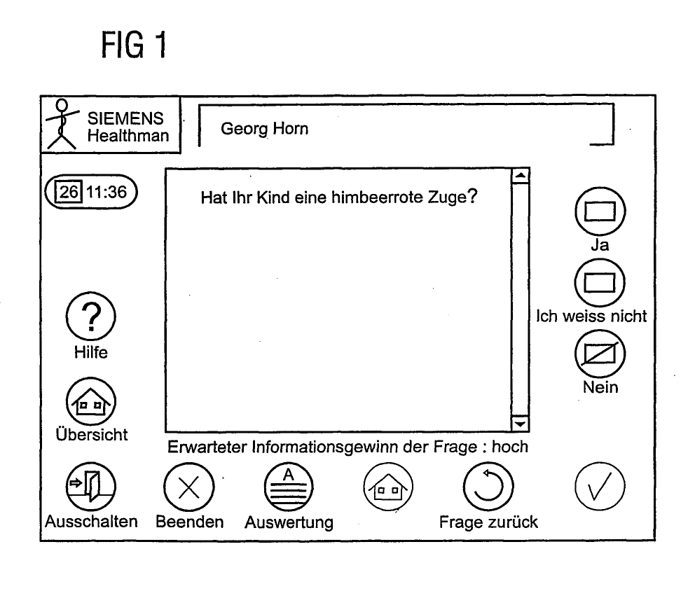

FIG. 1 shows one embodiment of an interface (monitor display) for the HealthMan dialogue and advice system,

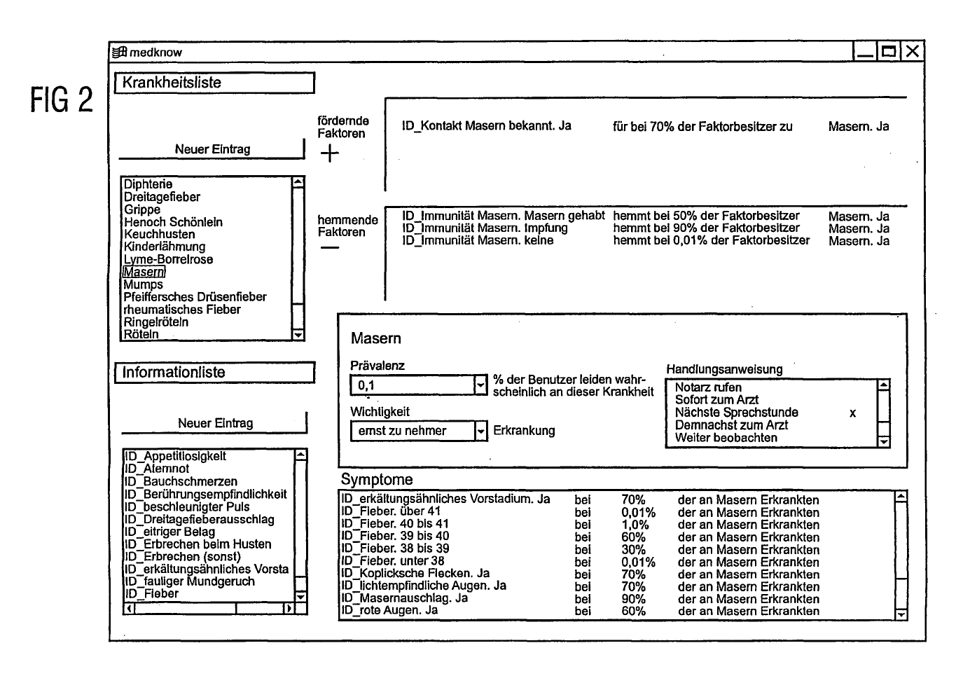

FIG. 2 shows a monitor display of the software tool MedKnow, and

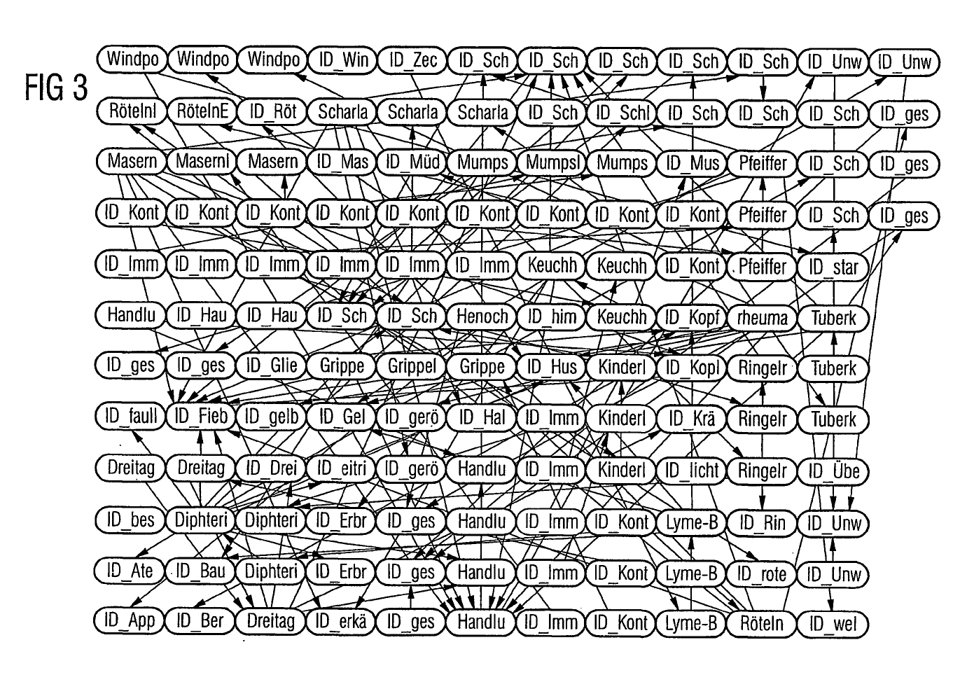

FIG. 3 shows a causal network for infections, which was produced automatically by means of a knowledge compiler.

The HealthMan project, which has been mentioned above and is illustrated in the form of an example of a history-taking process, provides a self-diagnosis service which makes use of a dialogue, for example with the patient, as health adviser, and thus considerably reduces the diagnostic load on the clinician. In particular, the HealthMan project is based on emulation on the clinician's history-taking process, that is to say it is based on an interactive process which is carried out dynamically by means of medical knowledge and which analyzes the already available information. Causal networks have been proven to be a suitable technique for this purpose because they ensure a knowledge acquisition process in a medically relevant direction, that is to say from debilitations to symptoms, and since the previous disposition to specific debilitations is taken into account. In particular, causal networks (Bayesian networks) represent a correct calculation means for the uncertainty on which, in particular, medical history taking is subject. The HUGIN library is used for inference for the purposes of the HealthMan project.

By way of example, the inventors have used this scenario of “initial assessment of the severity of normal children's debilitations” in order to test the method according to the invention. In conjunction with a number of pediatricians, networks have been developed for a number of sub-domains (for example infections, the breathing system, the skin, the abdomen, the eyes, and the ears). The system has been tested by a professional feasibility laboratory, and has likewise been assessed positively by the users (mothers of young children) and by the doctors involved.

The MedKnow software tool which has already been mentioned above is designed firstly to make it possible to formulate the medical knowledge of medical experts without them needing to have any specific knowledge relating to causal networks and probability theory, and, on the other hand, to ensure that the knowledge which is gained is complete in the sense that the causal network can be produced automatically and in its own right.

The MedKnow software tool uses two classes of random variables: illnesses and findings. A finding may play the role of a symptom or the role of a promoting or constraining factor for a debilitation. One example of the acquisition of necessary knowledge is illustrated in FIG. 2. All of the debilitations and findings are listed in the left-hand part of the window which is displayed on a computer monitor. The selected debilitation or the selected finding is displayed in the main part of the window. In the present case, the medical field of infections is displayed in the form of a model, with the debilitation “measles” being selected.

The upper part of the main window shows the promoting and constraining factors, in the present case contact with infected people and immunity. Furthermore, required probabilities must be specified in order to quantify the effect of the promoting and constraining factors. The significance of these required probabilities and the assumptions on which they are based are discussed in the attachment to the present description.

The central part of the main window in FIG. 2 shows the selected debilitation, its boundary probability and additional information which is used in the HealthMan project, for example the urgency of calling a doctor for advice. The lower part of the main window shows the symptoms of the debilitation together with the necessary probability of that debilitation actually causing the symptom.

A similar display is produced for a finding.

FIG. 3 shows the graphical representation of a causal network for infections, produced by a knowledge compiler in conjunction with the method according to the invention.

The production (in the present case the automatic production) of a causal network using the knowledge acquired as explained above can be subdivided into two task elements: the production of the graph (which is shown in FIG. 3) and the calculation of the necessary probability tables.

The production of the graphs is relatively simple: each debilitation and each finding is reproduced by a node, and additional nodes are produced separately for the gathering of promoting factors and for the gathering of constraining factors for each individual debilitation. Arrows are shown from the debilitations to the respective symptoms, from promoting factors to the respective joint nodes, and from the constraining factors to the respective joint nodes, as well as from the joint nodes to the respective debilitations (see FIG. 3).

The calculation of the necessary probability tables for the causal network is based on the specified probabilities and on the lattice type. For findings, the inventors have used lattices such as the so-called NoisyOR (F. V. Jensen: An Introduction to Bayesian Networks, UCL Press, 1996), NoisyMAX and NoisyELENI (R. Lupas Scheiterer: HealthMan Bayesian Network Description: Disease to Symptom Layer, Siemens AG, ZT IK 4, Internal Report, 1999). Debilitations have been modeled as promoting/constraining lattices (J. Horn: HealthMan Bayesian Network Description: Enhancing and Inhibiting Factors of Diseases. Siemens AG, ZT IK 4, Internal Report 1999).

The calculation of the required probabilities and of the tables relating to them can be found in the attachment to this description of the figures.

Patent claims:

1. A method for creation of a causal network on the basis of knowledge acquisition, characterized in that the knowledge is acquired separately from the creation of the causal network and the knowledge acquisition process comprises the following steps:
gathering a relevant knowledge, and
structuring of the gathered knowledge into a structured representation, which is complete to the extent that the causal network can be created automatically by means of a compiler.

2. The method as claimed in claim 1, characterized in that a subset is produced from the gathered knowledge by means of a mathematical method, such that the representation which results from this is complete.

3. The method as claimed in claim 1 or 2, characterized in that the relevant knowledge is gathered by means of a software tool.

4. The method as claimed in claim 3, characterized in that the relevant knowledge is gathered by means of the software tool with a dialogue being carried out on a display device.

5. The method as claimed in claim 4, in which knowledge is gathered from the medical field, characterized in that the software tool is designed to specify debilitations and findings, relationships between debilitations and findings, and specific boundary probabilities and conditional probabilities, and is designed to ensure that the gathered knowledge is sufficiently complete that the causal network can be created automatically by means of a compiler.

6. The method as claimed in claim 5, characterized in that the software tool uses the debilitations and the findings as random variables.

7. The method as claimed in claim 5 or 6, characterized in that a selected debilitation, its boundary probability and additional information are displayed on the display device.

8. The method as claimed in claim 7, characterized in that the additional information includes promoting and constraining factors relating to the selected debilitation.

9. The method as claimed in claim 8, characterized in that probabilities are specified which relate to quantification of effects of promoting and constraining factors.

10. The method as claimed in one of claims 5 to 9, characterized in that the symptoms of a selected debilitation are displayed, together with the conditional probability that this debilitation causes the symptom.
